(19) United States
(12) Patent Application Publication
(10) Pub. No.: US 2009/0208186 A1
(43) Pub. Date: Aug. 20, 2009

(54) Varying UV and Near IR Light to Interfere With Camcorder Piracy

(75) Inventor: Youngshik Yoon, Valencia, CA (US)

Correspondence Address: Thomson Licensing LLC, P.O. Box 5312, Two Independence Way, PRINCETON, NJ, 08543-5312, US

(73) Assignee: Thomson Licensing

(21) Appl. No.: 12/086,163

(22) PCT Filed: Jun. 16, 2006
(86) PCT No.: PCT/US2006/023392

§ 371 Date: Jan. 5, 2009

(30) Foreign Application Priority Data
Jan. 5, 2006 (KR) 60756514

(51) Int. Cl. H04N 5/91

(52) U.S. Cl. 386/94

(57) ABSTRACT

An inventive method varies light within a wavelength range of ultraviolet to infrared coincident with media content being projected. In an exemplary embodiment, the wavelength light is varied with a wavelength in a range that includes 360, 370, 380, 390, 650, 660, 670, 680 and 690 nanometers. Preferably, the varying light is projected from behind a screen onto which the protected content is projected. Also, the varying light is projected onto different locations on a screen onto which the media content is projected.

### FIELD OF THE INVENTION

This invention relates to a technique for preventing the recording of protected content, in particular, preventing copying of viewed content by a video recording device such as a camcorder.

### BACKGROUND OF THE INVENTION

Advances in the development of portable video recording devices, often known as camcorders, has lead to the development of ever smaller high quality devices available at relatively low prices. The proliferation of small, high-quality camcorders has lead to an increase in unauthorized recording of motion picture films. Motion picture film pirates can now easily sneak a commonly available camcorder into a motion picture theater and record a copy of the displayed film. In many instances, the quality of the recorded movie will be sufficient to generate large scale sales of illegal copies.

The problem of illegal camcorder recording of movies has prompted efforts to alter the display of the movie to sufficiently impair the quality of the recorded copy as to make it worthless for sale. Past attempts to render camcorder recordings unusable have made use of IR (Infrared) light to interfere with the camcorder imager. Several past attempts have made use of an IR laser, but such lasers usually have only one particular wavelength and the use of a laser can raise a safety issue, as well as the problem of tuning the wavelength. However, the improvement of IR blocking filters in the consumer market can effectively block the IR from entering the camcorder's imager. Other attempts to eliminate illegal camcorder recording have made use of a wide spectrum strobe lamp (e.g. Xenon strobe lamp) with an IR transmitting filter or cold mirror. This approach suffers from the short lifetime of the lamp because of high frequency power control. Furthermore, such lamps often do not generate various ranges of wavelengths.

Accordingly, there is a need for preventing recording of viewed protected content by recording devices, such as camcorders.

### SUMMARY OF THE INVENTION

An inventive method varies light within a wavelength range of ultraviolet to infrared coincident with media content being projected. In an exemplary embodiment, the wavelength light is varied with a wavelength in a range that includes 360, 370, 380, 390, 650, 660, 670, 680 and 690 nanometers. Preferably, the varying light is projected from behind a screen onto which the protected content is projected. Also, the varying light is projected onto different locations on a screen onto which the media content is projected.

In an alternative embodiment of the invention, an apparatus includes a filter with variable optical transmittance for varying light within a wavelength range of ultraviolet to infrared onto a screen on which media content is projected. Preferably, the different optical transmittances include wavelengths that include one of 360, 370, 380, 390, 650, 660, 670, 680 and 690 nanometers. The filter is a disk that is rotatable to change the optical transmittance of light projected through the disk.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 shows a cross-sectional view of a projector, in accordance with the present principles, which makes use of UV and IR filters to add UV and IR light to adversely impact camcorder recording;

FIG. 2 shows a frontal view of a filter disk for use with the projector of FIG. 1;

FIG. 3 depicts a graph of the light material suitable for use in making the filter of FIG. 2; and

FIG. 4 shows the light sensitivity of a typical camcorder imager.

It should be understood that the drawings are for purposes of illustrating the concepts of the invention and are not necessarily the only possible configuration for illustrating the invention.

### DETAILED DESCRIPTION OF THE INVENTION

Typically camcorders are designed for night vision with no extra cost because of the high sensitivity of the imager's silicon cell at near infrared IR wavelength range. Starting from this point, picking up near UV & IR, movie piracy can be prevented by scanning such light across the screen on which content is viewed so it will be recorded by the camcorder. However, far UV & IR have to be filtered out due to safety reasons. Using an optical filter disk, different wavelengths of light can be generated and scanned across the viewing screen. As a result, the picture will be washed out if pirate tries to capture the image on the screen.

The invention prevents copying of viewed content with a camcorder by projecting light at successively different wavelengths invisible to the human eye, near infrared IR light and UV (Ultraviolet) light close to visible waveband. The ultraviolet light will not impact the movie viewer but will be seen and recorded by a camcorder image capturing operation. The invention employs an optical disk with multiple segments with different wavelength cut-offs to deliver an interfering light that varies in wavelength across a spectrum that is not visible to the human eye but detectable by a camcorder's image recording. Providing different wavelengths of light assures that all but one of the wavelengths of light will interfere with the camcorder's recording of the content because not all the wavelengths of projected interfering light will be blocked by a single filter lens or an infrared IR blocking filter on the camcorder.

Referring to the schematic 10 of Figure, there is a shown an ultraviolet UV & infrared IR projector that operates to filter out light in the visible waveband. However, light with wavelengths near the ultraviolet UV & infrared IR band can be visible because they are close to the visible waveband. Light from an exemplary xenon lamp 16 is projected through an ultraviolet UV filter 14 sitting on a heat sink 13 and having cutoff wavelengths up to 350 nanometers. Light emanating from the ultraviolet UV filter 14 then passes through an infrared IR filter 15. The infrared IR filter cuts off light with wavelengths beginning at 990 nanometers and above. The cut-off wavelengths of the UV filter 14 and IR filter 15 can be achieved by selective use of a glass material's light transmission curve and the silicon cell sensitivity of a camcorder's imager. As shown by an exemplary transmittance curve 30 in FIG. 3, where about 92% of the light is from about 300 nanometers wavelength and begins to decay down to only about 60% of the light is passed at around 2300 nanometers of wavelength. The light transmittance profile of the glass material desired in a blocking filter is considered in view of the silicon cell sensitivity in a camcorder imager to light from a viewed image.

A comparison of a light transmittance curve 42 of a near infrared NIR blocking filter and a light sensitivity response 41 of silicon cell in a camcorder imager are shown in the curve 40 of FIG. 4. The near infrared NIR blocking filter will pass about 90% to 95% percent of light with a wavelength of about 390 to 750 nanometers. In this wavelength range of the blocking filter, the silicon cell in the camcorder's imager is sensitive to about 40% to 87% of the light passed by the blocking filter. As can be seen, the camcorder's imager can still allow for recording of a substantial amount of light near the visible range and infrared range. However, knowing the light transmittance of a blocking filter and silicon sensitivity range of a camcorder imager can enable a filtering scheme that will protect projected film or movie content from a piracy effort by an operated camcorder.

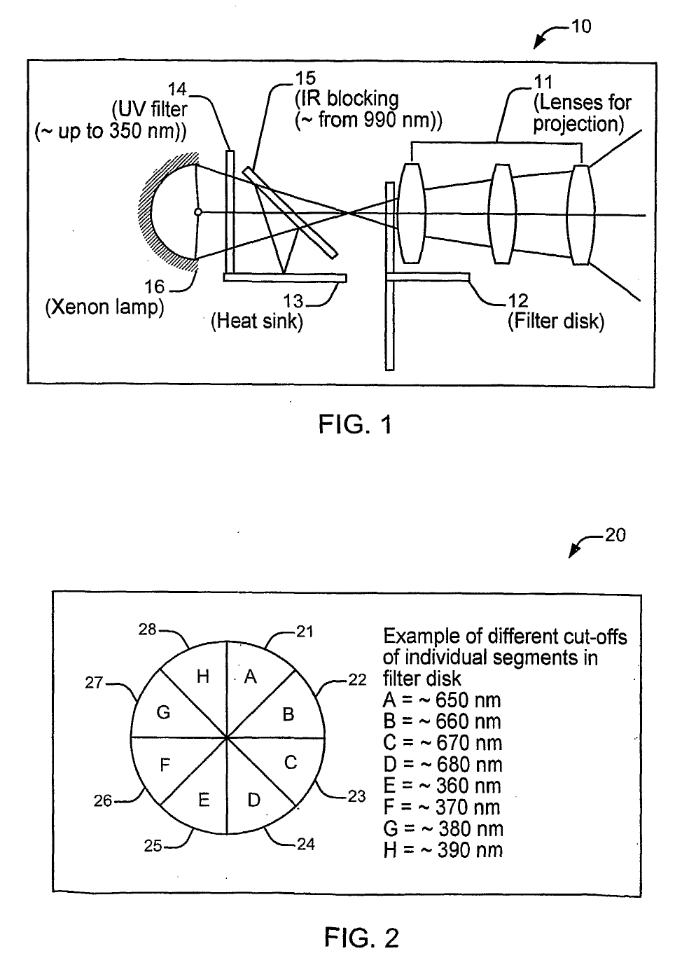

Referring to the exemplary projector 10 in FIG. 1, it is shown that light from the infrared IR filter 15 is then passed through a rotated filter disk 12 that begins to decay light transmittance at different wavelength cut-offs. The light from the filter disk 12 is passed through lenses 12 for projection onto a viewing area. One such viewing area can be a movie theatre screen (not shown).

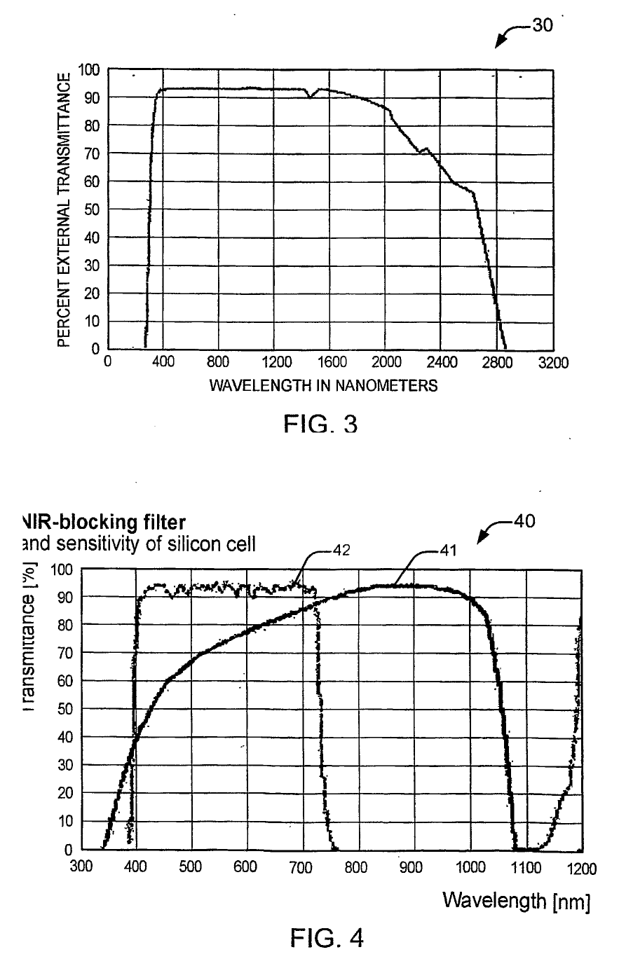

An exemplary filter disk 20 is shown in FIG. 2, where multiple segments A through H (21 through 28) have different wavelength cut-off properties to over come any single filter blocking on a camcorder device. For example, in the exemplary filter disk 20 of FIG. 2, the cut-off wavelengths in nanometers progress through 390, 380, 370, 360, 680, 670, 660, and 650. By rotating the disk and selectively passing wavelengths of light inside the near infrared block filter's transmittance range of about 90% to 95%, interference light variations can be projected that is picked up by the camcorder's imager and distorts the image recorded. Any attempt to place a filter blocking lens on the camcorder to block the distorting light variations will fail to capture the entire range of wavelength variations in the distorting light.

The exemplary projector 10 with inventive filter disk can be placed behind a viewing screen or project near utltraviolet UV and infrared IR light from a projection room. The use of a polygon mirror or crystal mirror ball (not shown) can help fast scan and create random spots onto a viewing screen, so viewers cannot recognize any spots from such a projector that would still be picked up by a camcorder imager. The camcorder anti-piracy can be achieved by projecting IR light and UV (Ultraviolet) light close to visible waveband. The UV light will not impact the movie viewer but will sufficiently interfere with a camcorder imager without any effect by a typical IR filter. In practice, different cut-offs of individual segments in filter disk can deliver light detectable by the camcorder, but not discernable by a viewer. Also, different wavelengths can go through any particular IR blocking filter, which has only a single cut-off wavelength. Thus, illegal piracy can be prevented.

Having described a preferred embodiment for varying wavelength of light to interfere with camcorder operated attempts to record film projected content, it is noted that modifications and variations can be made by persons skilled in the art in light of the above teachings. For example, filter disk segments with wavelength cut-offs different than those provided herein can be used as well as a fewer or greater number of disk segments can be employed to alter the progression of cut-off wavelengths. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A method comprising:
varying light within a wavelength range of ultraviolet to infrared coincident with media content being projected.

2. The method of claim 1, wherein the wavelength range includes one of 360, 370, 380, 390, 650, 660, 670, 680 and 690 nanometers.

3. The method of claim 1, further comprising projecting the varying light from behind a screen onto which the protected content is projected.

4. The method of claim 1, further comprising projecting the varying light onto different locations on a screen onto which the media content is projected.

5. The method of claim 1, wherein the wavelength range through 360, 370, 380, 390, 650, 660, 670, 680 and 690 nanometers.

6. The method of claim 5, further comprising projecting the varying light from behind a screen onto which the protected content is projected.

7. The method of claim 5, further comprising projecting the varying light onto different locations on a screen onto which the content is projected.

8. The method of claim 1, further comprising scanning the varying light at a rate rendering the varying light undiscernable by a viewer.

9. The method of claim 1, wherein the media content is a movie film projected onto a theatre screen.

10. An apparatus comprising:
a filter having a variable optical transmittance for varying light within a wavelength range of ultraviolet to infrared onto a screen on which media content is projected.

11. The apparatus of claim 10, wherein the different optical transmittances comprise wavelengths that include one of 360, 370, 380, 390, 650, 660, 670, 680 and 690 nanometers.

12. The method of claim 10, wherein the different optical transmittances comprise wavelengths of 360, 370, 380, 390, 650, 660, 670, 680 and 690 nanometers.

13. The method of claim 10, wherein the filter is a disk that is rotatable to change the optical transmittance of light projected through the disk.

14. The method of claim 13, wherein the filter disk comprises regions with said different optical transmittances.

15. The method of claim 13, wherein the disk is positionable in a light path after an ultraviolet filter and an infrared blocking filter.
